(19) United States
(12) Patent Application Publication
(10) Pub. No.: US 2019/0119461 A1
(43) Pub. Date: Apr. 25, 2019

(54) STABILIZED POLYURETHANE POLYOL BLENDS CONTAINING HALOGENATED OLEFIN BLOWING AGENT

(71) Applicant: Arkema Inc., King of Prussia, PA (US)

(72) Inventors: Benjamin Bin Chen, Wayne, PA (US); Joseph S. Costa, Giberstsville, PA (US)

(21) Appl. No.: 16/228,844

(22) Filed: Dec. 21, 2018

Related U.S. Application Data
(62) Division of application No. 14/893,635, filed on Nov. 24, 2015, now abandoned.
(60) Provisional application No. 61/827,816, filed on May 28, 2013.

(51) Int. Cl. C08J 9/00; C08G 77/46; C08G 18/20; C08J 9/14; C08G 18/32

(52) U.S. Cl. CPC C08J 9/0061; C08G 77/46; C08G 18/2027; C08J 9/0028; C08J 9/144; C08G 18/3206; C08G 2101/00; C08J 2201/022; C08J 2383/12; C08J 2205/052; C08J 2205/10; C08J 2375/04; C08J 2483/12; C08J 2203/162

(57) ABSTRACT

The present invention relates to imidazole and/or its derivative as polyurethane or polyisocyanurate foam catalyst in the presence of Low Global Warming Potential (GWP) halogenated olefinic blowing agents, such as the hydrochlorofluoroolefin (HCFO) HCFO-1233zd. More particularly, the present invention relates to catalyst compositions comprising imidazole and/or its derivative. The present invention further relates to the stable pre-blend formulations and resulting polyurethane or polyisocyanurate foams. A method for stabilizing thermosetting foam blends comprises combining: (a) a polyisocyanate and, optionally, isocyanate compatible raw materials; and (b) a polyol pre-mix composition comprising a halogenated olefinic blowing agent, a polyol, a surfactant, and a catalyst, wherein the catalyst comprises substituted imidazole having C2 or greater substitutions at the N1 nitrogen and/or its derivative. The resultant polyurethane or polyisocyanurate foams have uniform cell structure with little or no foam collapse.

The present application is a divisional application of U.S. patent application Ser. No. 14/893,635 filed Nov. 24, 2015 which is the national phase under 35 USC § 371 of prior PCT International Application Number PCT/US2014/038690 filed May 20, 2014 which designated the United States of America and claimed priority to U.S. Provisional Patent Application Ser. No. 61/827,816 filed May 28, 2013.

### FIELD OF THE INVENTION

The present invention relates to substituted imidazole and/or its derivative as polyurethane or polyisocyanurate foam catalyst in the presence of Low Global Warming Potential (GWP) or halogenated olefinic blowing agent, such as hydrochlorofluoroolefin (HCFO) HCFO-1233zd. More particularly, the present invention relates to catalyst composition comprising substituted imidazole having C2 or greater substitutions at the N1 nitrogen and/or its derivative. The present invention further relates to the stable pre-blend formulations and resulting polyurethane or polyisocyanurate foams.

### BACKGROUND OF THE RELATED ART

Rigid polyurethane (PUR) or polyisocyanurate (PIR) foam has been an essential part of the building and construction and appliance industry since it was first used to replace mineral fiber in the late 1950s, providing both insulation as well as structural support. The use of fluorocarbon blowing agent provided the necessary expansion, but more importantly, provided superior insulation properties to the foam.

Fluorocarbons, however, were not without their issues. In the mid 1970s it was discovered that chlorofluorocarbons (CFC) were affecting the ozone layer in the upper atmosphere. Thus began a higher level of scrutiny and regulation of these materials, starting with the phase-out of CFCs in the mid 1990s per the Montreal protocol. Since that phase-out, the rigid polyurethane foam industry has faced a constantly evolving period of change in the availability and use of different blowing agents. Although the regulations have imposed a significant cost burden on system suppliers and foam manufacturers due to the need to ensure that new blowing agents perform acceptably and products conform to various regulations, the industry continues to adapt to these changes, developing a much greater understanding of the properties and performance attributes of the products. During this same period, similar scrutiny was being placed on energy consumption. In the late 1970s and 1980s, several states introduced energy efficiency standards for domestic refrigerators. Then in 1990, the Department of Energy introduced federal Minimum Energy Performance Standards (MEPS) for household refrigeration. Since then, these standards have been updated, on a regular basis with more stringent energy requirements

Currently used blowing agents for thermoset foams include HFC-134a, HFC-245fa, HFC-365mfc, which have relatively high global warming potential, and hydrocarbons such as pentane isomers, which are flammable and have low energy efficiency. Therefore, new alternative blowing agents are being sought. Halogenated hydroolefinic materials such as hydrofluoropropenes and/or hydrochlorofluoropropenes have generated interest as replacements for HFCs. The inherent chemical instability of these materials in the lower atmosphere provides for a low global warming potential and zero or near zero ozone depletion properties desired.

It is convenient in many applications to provide the components for polyurethane or polyisocyanurate foams in pre-blended formulations. Most typically, the foam formulation is pre-blended into two components. The polyisocyanate and optional isocyanate compatible raw materials comprise the first component, commonly referred to as the A-side component. A polyol or mixture of polyols, surfactant, catalyst, blowing agent, and other isocyanate reactive and non-reactive components comprise the second component, commonly referred to as the B-side component. Accordingly, polyurethane or polyisocyanurate foams are readily prepared by bringing together the A-side and B-side components either by hand mix for small preparations or, preferably, machine mix techniques to form blocks, slabs, laminates, pour-in-place panels and other items, spray applied foams, froths, and the like.

It has been found that B-side compositions, which contain certain hydrohaloolefins such as HFO-1234ze and HCFO-1233zd, exhibit a reduced shelf life. It has been found that if the polyol pre-mix composition contains halogenated olefin blowing agents, and the B-side is aged prior to mixing with the polyisocyanate, the A-side, the foams are of lower quality and may even collapse during the formation of the foam. The present inventors have found that the poor foam structure is attributed to the reaction of certain catalysts with certain hydrohaloolefins, including HFO-1234ze and HCFO-1233zd, which results in the partial decomposition of the blowing agent and, subsequently, the undesirable modification of the polymeric silicone surfactants typically present in the B-side.

One way to overcome this problem, could be to separate the blowing agent, surfactant, and catalyst, and introduce them using a stream separate from the A-side or B-side side components. However, such reformulation or process change is not a preferred solution. The present inventors discovered a more favorable method of utilizing catalysts that have a lower reactivity towards blowing agents.

The commonly used catalysts for polyurethane chemistry can be classified into two broad categories: amine compounds and metallic salts. Amine catalysts are generally selected based on whether they drive: the polymerization reaction (gel catalysis), in which polyfunctional isocyanates react with polyols to form polyurethane, or the blow catalysis (gas-producing catalysis), in which the isocyanate reacts with water to form polyurea and carbon dioxide. Amine catalysts can also drive the isocyanate trimerization reaction. Since some amine catalysts will drive all three reactions to some extent, they are often selected based on how much they favor one reaction over another.

U.S. Patent Application Publication No. 2009/0099274 discloses the use of sterically hindered amines that have low reactivity with hydrohaloolefins. In paragraphs [0031], [0032], and [0033], imidazole, n-methylimidazole, and, 1,2-dimethylimidazole were cited as useful sterically hindered amine. Sterically hindered amines are known to be gelling catalysts. Gelling catalysts are characterized in that they have higher selectivity for catalyzing the gelling or urethane reaction over the blowing or urea reaction. Such catalysts are expected to perform poorly in systems containing high concentrations of water because of their inability to activate water towards isocyanate. Accordingly, sterically hindered amines have good functionality as gelling catalysts, but perform poorly in polyurethane system that require balanced blow and gel catalysis. In such systems, in order to maintain the reactivity necessary, the amount of catalyst used would have be increased. Additionally, since typically used amine catalysts do not chemically bonded to the polymer foam, the catalysts will eventually leave the polymer foam as volatile organic compounds (VOCs) which may cause adverse health effects. Thus, a method for stabilizing thermosetting foam blends, the resulting stable pre-mix blend formulations, and the environmentally-friendly polyurethane or polyisocyanurate foams having good foam structure remain highly desirable.

### BRIEF SUMMARY OF THE INVENTION

It has now been discovered that substituted imidazole having C2 or greater substitutions at the N1 nitrogen catalysts and/or their derivatives have less reactivity with hydrohaloolefins than traditional catalysts and have better catalytic performance than sterically hindered amine catalysts. Specifically, it has now been discovered that catalyst composition comprising imidazole with C2 or greater substituents at the N1 nitrogen provide for stable polyol pre-mix B-side in thermosetting foam blends, including blends having halogenated olefinic blowing agents; while also providing balanced catalytic activity. The stabilization method was found to have prolonged the shelf life of the pre-mix and enhanced the foam characteristics of the resultant foam.

Accordingly, catalyst composition comprising substituted imidazole having C2 or greater substitutions at the N1 nitrogen are favorable replacements for traditional catalysts and for sterically hindered amine catalysts, such as dimethylcyclohexylamine (DMCHA) and pentamethyldiethyltriamine (PMDETA), as a component of a polyol B-side pre-mix blend. The method of the present invention was found to surprisingly stabilize the pre-mix blends, provide a long shelf life and provide a balanced catalytic activity. The resultant foams of the present invention were found to have enhanced foam characteristics and may be employed to meet the demands of low or zero ozone depletion potential, lower global warming potential, low VOC content, and low toxicity, thereby making them environmentally-friendly.

In one embodiment, the present invention provides a polyol B-side pre-mix composition which comprises a halogenated olefinic blowing agent, a polyol, a surfactant, and a catalyst composition comprising a substituted imidazole having C2 or greater substitutions at the N1 nitrogen catalyst. In another embodiment, the present invention provides a polyol B-side pre-mix composition which comprises a halogenated olefinic blowing agent, a polyol, a surfactant, and a catalyst composition comprising a substituted imidazole having C2 or greater substitutions at the N1 nitrogen catalyst. The catalyst composition may comprise more than one amine catalyst. In such instances, the substituted imidazole having C2 or greater substitutions at the N1 nitrogen catalyst preferably comprises greater than 50 wt % of a total of the amine catalysts. That is to say, when more than one amine catalyst is present, the one or more substituted imidazole having C2 or greater substitutions at the N1 nitrogen catalysts comprises, in total, greater than 50 wt % of the total amine catalysts in the catalyst composition.

The blowing agent may comprise a halogenated hydroolefin, optionally in combination with co-blowing agents such as hydrocarbons, alcohols, aldehydes, ketones, ethers/diethers, or CO₂ generating materials, or combinations thereof. The surfactant may be a silicone or non-silicone surfactant. In some embodiments, the present invention may further include metallic salts, such as, for example, alkali earth carboxylates, alkali carboxylates, and carboxylates of bismuth (Bi), zinc (Zn), cobalt (Co), tin (Sn), cerium (Ce), lanthanum (La), aluminum (Al), vanadium (V), manganese (Mn), copper (Cu), nickel (Ni), iron (Fe), titanium (Ti), zirconium (Zr), chromium (Cr), scandium (Sc), calcium (Ca), magnesium (Mg), strontium (Sr), and barium (Ba). These metal salts can be readily formulated into a typical polyol pre-mix.

In another embodiment the present invention provides a stabilized thermosetting foam blend which comprises: (a) a polyisocyanate and, optionally, isocyanate compatible raw materials, an A-side; and (b) a polyol pre-mix composition which comprises a halogenated olefinic blowing agent, a polyol, a surfactant, and a catalyst composition comprising a substituted imidazole having C2 or greater substitutions at the N1 nitrogen catalyst. In at least one embodiment the catalyst composition of the stabilized thermosetting foam blend may comprise more than one amine catalyst. In such instances, the substituted imidazole having C2 or greater substitutions at the N1 nitrogen catalyst preferably comprises greater than 50 wt % of a total of the amine catalysts.

In a further embodiment, the present invention is a method for stabilizing thermosetting foam blends which comprises combining: (a) a polyisocyanate and, optionally, isocyanate compatible raw materials; and (b) a polyol pre-mix composition which comprises a halogenated olefinic blowing agent, a polyol, a surfactant, and a catalyst composition comprising a substituted imidazole having C2 or greater substitutions at the N1 nitrogen catalyst. In at least one embodiment the catalyst composition of the polyol pre-mix may comprise more than one amine catalyst. In such instances, the substituted imidazole having C2 or greater substitutions at the N1 nitrogen catalyst comprises greater than 50 wt % of a total of the amine catalysts.

It has unexpectedly been discovered that substituted imidazole having C2 or greater substitutions at the N1 nitrogen catalyst have less reactivity with halogenated olefinic blowing agents than traditional catalysts. The substituted imidazole having C2 or greater substitutions at the N1 nitrogen catalysts were also surprisingly found to have better catalytic performance than other catalysts, including sterically hindered amine catalysts. The use of substituted imidazole having C2 or greater substitutions at the N1 nitrogen catalysts in a polyol pre-mix blend composition surprisingly produced a thermoset blend composition that has prolonged shelf-life stability. The inventors of the present invention have further found that metallic salts, such as, for example, alkali earth carboxylates, alkali carboxylates, and carboxylates of bismuth (Bi), zinc (Zn), cobalt (Co), tin (Sn), cerium (Ce), lanthanum (La), aluminum (Al), vanadium (V), manganese (Mn), copper (Cu), nickel (Ni), iron (Fe), titanium (Ti), zirconium (Zr), chromium (Cr), scandium (Sc), calcium (Ca), magnesium (Mg), strontium (Sr), and barium (Ba) have good hydrofluoric acid (HF) scavenger activity and add to the stabilization effect of the substituted imidazole amine catalysts. For example, metallic salts having one or more functional carboxyl groups may be employed as a HF scavenger. Such metallic salts may include, for example, magnesium formate, magnesium benzoate, magnesium octoate, calcium formate, calcium octoate, zinc octoate, cobalt octoate, stannous octoate, and dibutyltindilaurate (DBTDL). Optionally, a solvent may be utilized to dissolve the metallic salts for mixing with the polyol blend composition. Additionally, it is surprising and unexpected that the foams produced in accordance with the present invention by mixing a polyol pre-mix blend composition with a polyisocyanate have a uniform cell structure with little or no foam collapse.

### DETAILED DESCRIPTION OF CERTAIN EMBODIMENTS OF THE INVENTION

Polyurethane foaming was studied by using halogenated olefins blowing agents such as the hydrochlorofluoroolefin 1-chloro-3,3,3-trifluoropropene, commonly referred to as HCFO-1233zd. The blends for polyurethane foam typically include a polyol, a surfactant, an amine catalyst, a halogenated olefin, and a carbon dioxide (CO₂) generating material. It was surprisingly found that the substituted imidazole having C2 or greater substitutions at the N1 nitrogen catalyst used in the present invention resulted in improved stability of the foam blends over time. Additionally, the resultant foams surprisingly were found to have a uniform cell structure with little or no foam collapse. Furthermore, the foam blends showed unexpected further enhanced stability when a metal salt, such as an alkali earth salt, was also used.

Without being held to the theory, it is believed that the problem of the diminished shelf-life stability of the two-component systems, especially those using a halogenated olefinic blowing agent such as HCFO-1233zd, is related to the reaction of the halogenated olefins with the amine catalyst. The reaction produces hydrofluoric acid (HF) which attacks the silicone surfactant in situ. This side reaction was confirmed by hydrogen, fluorine, and silicon nuclear magnetic resonance (NMR) spectra and gas chromatography-mass spectrometry (GC-MS). This effect can be summarized as the Nucleophilic attack of the amine catalyst on the C₁ of the HCFO-1233zd halogenated olefin. The present invention reduces such detrimental interaction by decreasing the reactivity of the HCFO-1233zd halogenated olefin with the amine catalyst by using a substituted imidazole having C2 or greater substitutions at the N1 nitrogen catalyst. The reduction in degradation of the olefin is thought to be tied to the structure of the substituted imidazole having C2 or greater substitutions at the N1 nitrogen catalyst of the present invention.

Known methods of overcoming this effect have focused on the use of various stabilizers to serve as scavengers for hydrofluoric acid. These stabilizers include alkenes, nitroalkanes, phenols, organic epoxides, amines, bromoalkanes, bromoalcohols, and alpha-methylstyrene, among others. More recently, methods have focused on the use of sterically hindered amines and organic acids, but these sacrifice catalytic activity.

The inventors of the present invention have now discovered the favorable use of substituted imidazole having C2 or greater substitutions at the N1 nitrogen catalyst, such as N-hydroxypropyl-2-ethyl-4-methyl imidazole, N-hydroxypropyl-4-methyl imidazole, N-hydroxyethyl-4-methyl imidazole, N-hydroxypropyl-2-methyl imidazole, N-hydroxyethyl-2-ethyl-4-methyl imidazole, and, N-hydroxyethyl-2-methyl imidazole, which were found to have significantly reduced reactivity with the halogenated olefins, such as HCFO-1233zd (E and/or Z) and HFO 1234ze (E and/or Z), than traditional catalysts and better catalytic activity than sterically hindered amine catalysts. The inventors of the present invention have further found that metallic salts, such as, for example, alkali earth carboxylates, alkali carboxylates, and carboxylates of bismuth (Bi), zinc (Zn), cobalt (Co), tin (Sn), cerium (Ce), lanthanum (La), aluminum (Al), vanadium (V), manganese (Mn), copper (Cu), nickel (Ni), iron (Fe), titanium (Ti), zirconium (Zr), chromium (Cr), scandium (Sc), calcium (Ca), magnesium (Mg), strontium (Sr), and barium (Ba) have good hydrofluoric acid (HF) scavenger activity and add to the stabilization effect of the substituted imidazole having C2 or greater substitutions at the N1 nitrogen catalysts. For example, metallic salts having one or more functional carboxyl groups may be employed as HF scavengers. Such metallic salts may include, for example, magnesium formate, magnesium benzoate, magnesium octoate, calcium formate, calcium octoate, zinc octoate, cobalt octoate, stannous octoate, and dibutyltindilaurate (DBTDL).

The present invention thus provides a polyol pre-mix composition, a B-side, which comprises a halogenated olefinic blowing agent, a polyol, a surfactant, and a catalyst composition comprising a substituted imidazole having C2 or greater substitutions at the N1 nitrogen catalyst. In another embodiment, the present invention provides a polyol pre-mix composition which comprises a halogenated olefinic blowing agent, a polyol, a surfactant, and a catalyst composition comprising a substituted imidazole having C2 or greater substitutions at the N1 nitrogen catalyst. The catalyst composition may comprise more than one amine catalyst. In such instances, the substituted imidazole having C2 or greater substitutions at the N1 nitrogen catalyst preferably comprises greater than 50 wt % of a total of the amine catalysts. That is to say, the one or more substituted imidazole having C2 or greater substitutions at the N1 nitrogen catalyst is, in total, greater than 50 wt % of the total amine catalysts in the catalyst composition.

In another embodiment, the present invention provides a stabilized thermosetting foam blend which comprises: (a) a polyisocyanate and, optionally, isocyanate compatible raw materials, an A-side; and (b) a polyol pre-mix, a B-side composition. In yet another embodiment, the present invention is a method for stabilizing thermosetting foam blends which comprises combining: (a) a polyisocyanate and, optionally, isocyanate compatible raw materials; and (b) a polyol pre-mix composition. The mixture according to this method produces a stable foamable thermosetting composition which can be used to form polyurethane or polyisocyanurate foams.

Commonly used catalysts for polyurethane chemistry can generally be classified into two broad categories: amine compounds and organic metal salts. Traditional amine catalysts have been tertiary amines, such as triethylenediamine (TEDA), dimethylcyclohexylamine (DMCHA), and dimethylethanolamine (DMEA). Amine catalysts are generally selected based on whether they drive the gelling reaction or the blowing reaction. In the gelling reaction, polyfunctional isocyanates react with polyols to form polyurethane. In the blowing reaction, the isocyanate reacts with water to form polyurea and carbon dioxide. Amine catalysts can also drive the isocyanate trimerization reaction. These reactions take place at different rates; the reaction rates are dependent on temperature, catalyst level, catalyst type and a variety of other factors. However, to produce high-quality foam, the rates of the competing gelling and blowing reactions must be properly balanced.

The substituted imidazole having C2 or greater substitutions at the N1 nitrogen catalysts of the present invention include those imidazoles having substituents such as ethyl, propyl, and like groups. Preferably one of the groups further contains an ether and/or a hydroxyl group. For example, the substituted imidazole catalyst may be an alkanol substituted imidazole or an ether containing substituted imidazole. In one embodiment, all of the imidazole groups present in the catalyst molecule are tertiary amine groups. The catalyst, in one embodiment, may preferably contains at least one oxygen atom; these oxygen atoms may be present in the form of ether groups, hydroxyl groups or both ether and hydroxyl groups. For example, imidazoles of the formula:

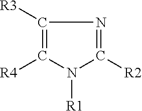

In which: R1 is a C2 to C10 alkyl group, or a —CₙH₂ₙ₋₁(OH)R′1, or a —CₙH₂ₙOCₘH₂ₘ₋₁(OH)R′1, or an alkenyl with C2 to C10, or an aryl with C7 to C17; where R′1 is H, or a straight, branched, or cyclic, C1 to C8 alkyl group, or an alkenyl with C2 to C10, or an aryl with C7 to C17, and n and m are independently from 1 to 6. R2, R3, and R4 are H, or OH, or a straight, or branched C1 to C10 alkyl group, or cyclic, or —CₙH₂ₙ₋₁(OH)R′1, or —CₙH₂ₙOCₘH₂ₘ₋₁OH)R′1 or an alkenyl with C2 to C10, or an aryl with C7 to C17; where R′1 is H, or a straight, or branched C1 to C8 alkyl group, or cyclic or an alkenyl with C2 to C10, or aryl with C7 to C17, and n and m are independently from 1 to 6.

As described above, catalysts function to control and balance the gelling and blowing reactions during foam formation. Tertiary amine catalysts have their own specific catalytic characteristics such as gelling, blowing, and crosslinking activity. As would be appreciated by one having ordinary skill in the art, these catalytic activities have a strong relationship with foam properties such as rise profile, blowing efficiency, moldability, productivity, and other properties of the resulting foam. Accordingly, the substituted imidazole having C2 or greater substitutions at the N1 nitrogen catalysts of the present invention can be further used with other amine or non-amine catalysts to balance the blow, gel, and trimerization catalysis reactions and produce a foam having the desired properties. The catalyst composition of the present invention may consist entirely of substituted imidazole having C2 or greater substitutions at the N1 nitrogen catalysts. Alternatively, the catalyst composition of the present invention may additionally include one or more amine or non-amine catalysts in combination with the substituted imidazole having C2 or greater substitutions at the N1 nitrogen catalysts.

The operable range of the quantity of the substituted imidazole having C2 or greater substitutions at the N1 nitrogen catalyst of the present invention can be varied with respect to the any other amine catalyst when an other amine catalyst(s) are employed. For example, when the substituted imidazole having C2 or greater substitutions at the N1 nitrogen catalyst is combined with another amine catalyst, the catalyst composition of the present invention preferrably comprises greater than 50 wt % of an substituted imidazole having C2 or greater substitutions at the N1 nitrogen catalyst.

The catalyst compositions of the present invention containing one or more substituted imidazole having C2 or greater substitutions at the N1 nitrogen catalysts have improved catalytic performance and produce a thermoset blend composition that has prolonged shelf-life stability. While other amine catalysts, when used, may aid in controlling the desired gelling and blowing reactions. The substituted imidazole having C2 or greater substitutions at the N1 nitrogen catalysts impart the desired catalytic performance and prolonged shelf-life stability of the thermoset blend. The catalyst compositions of the present invention reduce the detrimental interaction that can cause stability to decrease by decreasing the reactivity between the halogenated olefin and the amine catalyst.

Exemplary amine catalysts include: bis-(2-dimethylaminoethyl)ether; N,N-dimethylethanolamine; N-ethylmorpholine; N-methylmorpholine; N,N,N′-trimethyl-N′-hydroxyethyl-bisaminoethylether; N-(3-dimethylaminopropyl)-N,N-diisopropanolamine; N,N-bis(3-dimethylaminopropyl)-N-isopropanolamine; 2-(2-dimethylaminoethoxy)ethanol; N,N,N′-trimethylaminoethyl-ethanolamine; and 2,2′-dimorpholinodiethylether, and mixtures thereof. N-(3-dimethylaminopropyl)-N,N-diisopropanolamine, N,N-bis(3-dimethylaminopropyl)-N-isopropanolamine, 1,3-propanediamine, N′-(3-dimethylamino)propyl-N,N-dimethyl-, triethylenediamine, 1,2-dimethylimidazole, 1,3-propanediamine,N′-(3-(dimethylamino)propyl)-N,N-dimethyl-, N,N,N′N′-tetramethylhexanediamine, N,N″,N″-trimethylaminoethylpiperazine, N,N,N′,N′tetramethylethylenediamine, N,N-dimethylcyclohexylamine (DMCHA), Bis(N,N-dimethylaminoethyl)ether (BDMAFE), 1,4-diazadicyclo[2,2,2]octane (DABCO), 2-((2-dimethylaminoethoxy)-ethyl methyl-amino)ethanol, 1-(bis(3-dimethylamino)-propyl)amino-2-propanol, N,N′,N″-tris(3-dimethylamino-propyl)hexahydrotriazine, dimorpholinodiethylether (DMDEE), N.N-dimethylbenzylamine, N,N,N′,N″,N″-pentaamethyldipropylenetriamine, N,N′-diethylpiperazine, dicyclohexylmethylamine, ethyldiisopropylamine, dimethylcyclohexylamine, dimethylisopropylamine, methylisopropylbenzylamine, methylcyclopentylbenzylamine, isopropyl-sec-butyl-trifluoroethylamine, diethyl-(α-phenyethyl)amine, tri-n-propylamine, dicyclohexylamine, t-butylisopropylamine, di-t-butylamine, cyclohexyl-t-butylamine, de-sec-butylamine, dicyclopentylamine, di-(α-trifluoromethylethyl)amine, di-(x-phenylethyl)amine, triphenylmethylamine, and 1,1-diethyl-n-propylamine. Other amines include morpholines, imidazoles, ether containing compounds such as dimorpholinodiethylether, N-ethylmorpholine, N-methylmorpholine, bis(dimethylaminoethyl)ether, imidizole, n-methylimidazole, 1,2-dimethylimidazole, dimorpholinodimethylether, N,N,N′,N′,N″,N″-pentamethyldipropylenetriamine, and bis(diethylaminoethyl)ether, bis(dimethylaminopropyl)ether, and combinations thereof.

Exemplary non-amine catalysts include organometallic compounds containing bismuth, lead, tin, antimony, cadmium, cobalt, iron, thorium, aluminum, mercury, zinc, nickel, cerium, molybdenum, titanium, vanadium, copper, manganese, zirconium, magnesium, calcium, sodium, potassium, lithium or combination thereof such as stannous octoate, dibutyltin dilaurate (DGTDL), dibutyltin mercaptide, phenylmercuric propionate, lead octoate, potassium acetate/octoate, magnesium acetate, titanyl oxalate, potassium titanyl oxalate, quaternary ammonium formates, and ferric acetylacetonate, and combinations thereof.

Bismuth and zinc carboxylates may be favorably employed over mercury and lead based catalysts, due to the toxicity and the necessity to dispose of mercury and lead catalysts and catalyzed material as hazardous waste in the United States. However these may have shortcomings in pot life and in certain weather conditions or applications. Alkyl tin carboxylates, oxides and mercaptides oxides are used in all types of polyurethane applications. Organometallic catalysts are useful in two-component polyurethane systems. These catalysts are designed to be highly selective toward the isocyanate-hydroxyl reaction as opposed to the isocyanate-water reaction.

As would be appreciated by one having ordinary skill in the art, the substituted imidazole having C2 or greater substitutions at the N1 nitrogen catalyst of present invention may be selected, based on the various factors such as temperature, to produce balanced gelling and blowing reaction rates. Balancing the two competing reactions will produce high-quality foam structure. An ordinarily skilled artisan would further appreciate that the substituted imidazole having C2 or greater substitutions at the N1 nitrogen catalysts of the present invention may be employed alone, or in combination with other amine catalysts or metallic catalysts, to achieve the desired functional properties and characteristics of the resulting foam structure. This includes, but is not limited to, other catalysts that have gelling or blowing reaction functionality.

The halogenated olefinic blowing agent in the thermosetting foam blends in one embodiment of the present invention can include unsaturated halogenated hydroolefins such as hydrofluoroolefins (HFO), hydrochlorofluoroolefins (HCFO), or mixtures thereof, optionally further including hydrocarbons, alcohols, aldehydes, ketones, ethers/diethers or carbon dioxide generating materials. The preferred blowing agent in the thermosetting foam blend of the present invention is a hydrofluoroolefin (HFO) or a hydrochlorofluoroolefin (HCFO), alone or in a combination. Preferred hydrofluoroolefin (HFO) blowing agents contain 3, 4, 5, or 6 carbons, and include but are not limited to pentafluoropropenes, such as 1,2,3,3,3-pentafluoropropene (HFO 1225ye); tetrafluoropropenes, such as 1,3,3,3-tetrafluoropropene (HFO 1234ze, E and Z isomers), 2,3,3,3-tetrafluoropropene (HFO 1234yf), and 1,2,3,3-tetrafluoropropene (HFO1234ye); trifluoropropenes, such as 3,3,3-trifluoropropene (1243zf); tetrafluorobutenes isomers, such as (HFO 1345); pentafluorobutene isomers, such as (HFO1354); hexafluorobutene isomers, such as (HFO1336); heptafluorobutene isomers, such as (HFO1327); heptafluoropentene isomers, such as (HFO1447); octafluoropentene isomers, such as (HFO1438); nonafluoropentene isomers, such as (HFO1429); and hydrochlorofluoroolefins, such as 1-chloro-3,3,3-trifluoropropene (HCFO-1233zd) (E and Z isomers), 2-chloro-3,3,3-trifluoropropene (HCFO-1233xf), HCFO1223, 1,2-dichloro-1,2-difluoroethene (E and Z isomers), 3,3-dichloro-3-fluoropropene, 2-chloro-1,1,1,4,4,4-hexafluorobutene-2 (E and Z isomers), and 2-chloro-1,1,1,3,4,4,4-heptafluorobutene-2 (E and Z isomers). Preferred blowing agents in the thermosetting foam blends of the present invention include unsaturated halogenated hydroolefins with normal boiling points less than about 60° C. Preferred hydrochlorofluoroolefin blowing agents include, but are not limited to, E and/or Z 1233zd; 1,3,3,3-tetrafluopropene; and E and/or Z 1234ze.

The blowing agents in the thermosetting foam blend of the present invention can be used alone or in combination with other blowing agents, including but not limited to:

(a) hydrofluorocarbons including but not limited to difluoromethane (HFC32); 1,1,1,2,2-pentafluoroethane (HFC125); 1,1,1-trifluoroethane (HFC143a); 1,1,2,2-tetrafluorothane (HFC134); 1,1,1,2-tetrafluoroethane (HFC134a); 1,1-difluoroethane (HFC152a); 1,1,1,2,3,3,3-heptafluoropropane (HFC227ea); 1,1,1,3,3-pentafluopropane (HFC245fa); 1,1,1,3,3-pentafluobutane (HFC365mfc) and 1,1,1,2,2,3,4,5,5,5-decafluoropentane (HFC4310mee),

(b) hydrocarbons including but not limited to, pentane isomers and butane isomers;

(c) hydrofluoroethers (HFE) such as, C₄F₉OCH₃ (HFE-7100), C₄F₉OC₂H₅ (HFE-7200), CF₃CF₂OCH₃ (HFE-245cb2), CF₃CH₂CHF₂ (HFE-245fa), CF₃CH₂OCF₃ (HFE-236fa), C₃F₇OCH₃ (HFE-7000), 2-trifluoromethyl-3-ethoxydodecofluorohexane (HFE 7500), 1,1,1,2,3-hexafluoro-4-(1,1,2,3,3,3-hexafluoropropoxy)-pentane (HFE-7600), 1,1,1,2,2,3,5,5,5-decafluoro-3-methoxy-4-(trifluoromethyl)pentane (HFE-7300), ethyl nonafluoroisobutyl ether/ethyl nonafluorobutyl ether (HFE 8200), CHF₂OCHF₂, CHF₂—OCH₂F, CH₂F—OCH₂F, CH₂F—O—CH₃, cyclo-CF₂CH₂CF₂—O, cyclo-CF₂CF₂CH₂—O, CHF₂—CF₂CHF₂, CF₃CF₂—OCH₂F, CHF₂—O—CHFCF₃, CHF₂—OCF₂CHF₂, CH₂F—O—CF₂CHF₂, CF₃—O—CF₂CH₃, CHF₂CHF—O—CHF₂, CF₃—O—CHFCH₂F, CF₃CHF—O—CH₂F, CF₃—O—CH₂CHF₂, CHF₂—O—CH₂CF₃, CH₂FCF₂—O—CH₂F, CHF₂—O—CF₂CH₃, CHF₂CF₂—O—CH₃ (HFE254pc), CH₂F—O—CHFCH₂F, CHF₂—CHF—O—CH₂F, CF₃—O—CHFCH₃, CF₃CHF—O—CH₃, CHF₂—O—CH₂CHF₂, CF₃—O—CH₂CH₂F, CF₃CH₂—O—CH₂F, CF₂HCF₂CF₂—O—CH₃, CF₃CHFCF₂—O—CH₃, CHF₂CF₂CF₂—O—CH₃, CHF₂CF₂CH₂—OCHF₂, CF₃CF₂CH₂—O—CH₃, CHF₂CF₂—O—CH₂CH₃, (CF₃)₂CF—O—CH₃, (CF₃)₂CH—O—CHF₂, and (CF₃)₂CH—O—CH₃, and mixtures thereof; and

(d) C1 to C5 alcohols, C1 to C4 aldehydes, C1 to C4 ketones, C1 to C4 ethers and diethers and carbon dioxide generating materials.

The thermosetting foam blends of the present invention include one or more components capable of forming foam having a generally cellular structure and blowing agent(s). Examples of thermosetting compositions include polyurethane and polyisocyanurate foam compositions, preferably low-density foams, flexible or rigid.

The foams, preferably closed cell foams, prepared from a thermosetting foam formulations in accordance with the present invention may further include a stabilizing amount of an ester. When an ester is employed, the order and manner in which the blowing agent and ester is formed and/or added to the foamable composition does not generally affect the operability of the present invention.

In certain embodiments in the preparation of polyurethane polyol foams, the B-side polyol pre-mix can include polyols, silicone or non-silicone based surfactants, substituted imidazole catalysts, flame retardants or suppressors, acid scavengers, radical scavengers, fillers, and other stabilizers or inhibitors.

The polyol component, which can include mixtures of polyols, can be any polyol which reacts in a known fashion with an isocyanate in preparing a polyurethane or polyisocyanurate foam. Exemplary polyols include: glycerin-based polyether polyols such as Carpol® GP-700, GP-725, GP-4000, GP-4520; amine-based polyether polyols such as Carpol® TEAP-265 and EDAP-770, Jeffol® AD-310; sucrose-based polyether polyols, such as Jeffol® SD-360, SG-361, and SD-522, Voranol® 490, and Carpol® SPA-357; Mannich-based polyether polyols, such as Jeffol® R-425X and R-470X; sorbitol-based polyether polyols, such as Jeffol® S-490; and aromatic polyester polyols such as Terate® 2541 and 3510, Stepanpol® PS-2352, and Terol® TR-925.

The polyol pre-mix composition may also contain a surfactant. The surfactant is used to form a foam from the mixture, as well as to control the size of the bubbles of the foam so that a foam of a desired cell structure is obtained. Typically, a foam with small bubbles or cells therein of uniform size is desired since it has the most desirable physical properties such as compressive strength and thermal conductivity. Also, it is critical to have a foam with stable cells which do not collapse prior to foaming or during foam rise. Silicone surfactants for use in the preparation of polyurethane or polyisocyanurate foams are available under a number of trade names known to those skilled in this art. Such materials have been found to be applicable over a wide range of formulations allowing uniform cell formation and maximum gas entrapment to achieve very low density foam structures.

Exemplary silicone surfactants include polysiloxane polyoxyalkylene block co-polymer such as B8404, B8407, B8409, B8462 and B8465 available from Goldschmidt; DC-193, DC-197, DC-5582, and DC-5598 available from Air Products; and L-5130, L5180, L-5340, L-5440, L-6100, L-6900, L-6980, and L6988 available from Momentive. Exemplary non-silicone surfactants include salts of sulfonic acid, alkali metal salts of fatty acids, ammonium salts of fatty acids, oleic acid, stearic acid, dodecylbenzenedisulfonic acid, dinaphthylmetanedisulfonic acid, ricinoleic acid, an oxyethylated alkylphenol, an oxyethylated fatty alcohol, a paraffin oil, a caster oil ester, a ricinoleic acid ester, Turkey red oil, groundnut oil, a paraffin fatty alcohol, or combinations thereof. Typical use levels of surfactants are from about 0.4 to 6 wt % of polyol pre-mix, preferably from about 0.8 to 4.5 wt %, and more preferably from about 1 to 3 wt %.

Exemplary flame retardants include trichloropropyl phosphate (TCPP), triethyl phosphate (TEP), diethyl ethyl phosphate (DEEP), diethyl bis (2-hydroxyethyl) amino methyl phosphonate, brominated anhydride based ester, dibromoneopentyl glycol, brominated polyether polyol, melamine, ammonium polyphosphate, aluminum trihydrate (ATH), tris(1,3-dichloroisopropyl) phosphate, tri(2-chloroethyl) phosphate, tri(2-chloroisopropyl) phosphate, chloroalkyl phosphate/oligomeric phosphonate, oligomeric chloroalkyl phosphate, brominated flame retardant based on pentabromo diphenyl ether, dimethyl methyl phosphonate, diethyl N,N bis(2-hydroxyethyl) amino methyl phosphonate, oligomeric phosphonate, and derivatives thereof.

In certain embodiments, acid scavengers, radical scavengers, and/or other stabilizers/inhibitors are included in the pre-mix. Exemplary stabilizer/inhibitors include 1,2-epoxy butane; glycidyl methyl ether; cyclic-terpenes such as dl-limonene, 1-limonene, d-limonene; 1,2-epoxy-2,2-methylpropane; nitromethane; diethylhydroxyl amine; alpha methylstyrene; isoprene; p-methoxyphenol; m-methoxyphenol; dl-limonene oxide; hydrazines; 2,6-di-t-butyl phenol; hydroquinone; organic acids such as carboxylic acid, dicarboxylic acid, phosphonic acid, sulfonic acid, sulfamic acid, hydroxamic acid, formic acid, acetic acid, propionic acid, butyric acid, caproic acid, isocaprotic acid, 2-ethylhexanoic acid, caprylic acid, cyanoacetic acid, pyruvic acid, benzoic acid, oxalic acid, malonic acid, succinic acid, adipic acid, azelaic acid, trifluoroacetic acid, methanesulfonic acid, benzenesulfonic acid, and combinations thereof.

Other additives such as adhesion promoters, anti-static agents, antioxidants, fillers, hydrolysis agents, lubricants, anti-microbial agents, pigments, viscosity modifiers, UV resistance agents may also be included. Examples of these additives include: sterically hindered phenols; diphenylamines; benzofuranone derivatives; butylated hydroxytoluene (BHT); calcium carbonate; barium sulphate; glass fibers; carbon fibers; micro-spheres; silicas; melamine; carbon black; waxes and soaps; organometallic derivatives of antimony, copper, and arsenic; titanium dioxide; chromium oxide; iron oxide: glycol ethers; dimethyl AGS esters; propylene carbonate; and benzophenone and benzotriazole compounds.

In some embodiments of the present invention, an ester may be optionally added to a thermosetting foam blend. The addition of an ester was discovered to further improve the stability of the blend over time, as in extending shelf life of the pre-mix, and enhancing the properties of the resultant foam. Esters used in the present invention have the formula R—C(O)—O—R′, where R and R′ can be CₐH_{c-b}G_{b}, where G is a halogen such as F, Cl, Br, I, a=0 to 15, b=0 to 31, and c=1 to 31, and include esters that are the product of dicarboxylic acid, phosphinic acid, phosphonic acid, sulfonic acid, sulfamic acid, hydroxamic acid or combination thereof. Preferred esters are the products of an alcohol such as methanol, ethanol, ethylene glycol, diethylene glycol, propanol, isopropanol, butanol, iso-butanol, pentanol, iso-pentanol and mixtures thereof; and an acid such as formic, acetic, propionic, butyric, caproic, isocaprotic, 2-ethylhexanoic, caprylic, cyanoacetic, pyruvic, benzoic, oxalic, trifluoacetic, oxalic, malonic, succinic, adipic, zaelaic, trifluoroacetic, methanesulfonic, benzene sulfonic acid and mixture thereof. The more preferred esters are allyl hexanoate, benzyl acetate, benzyl formate, bornyl acetate, butyl butyrate, ethyl acetate, ethyl butyrate, ethyl hexanoate, ethyl cinnamate, ethyl formate, ethyl heptanoate, ethyl isovalerate, ethyl lactate, ethyl nonanoate, ethyl pentanoate, geranyl acetate, geranyl butyrate, geranyl pentanoate, isobutyl acetate, isobutyl formate, isoamyl acetate, isopropyl acetate, linalyl acetate, linalyl butyrate, linalyl formate, methyl acetate, methyl anthranilate, methyl benzoate, methyl butyrate, methyl cinnamate, methyl formate, methyl pentanoate, methyl propanoate, methyl phenylacetate, methyl salicylate, nonyl caprylate, octyl acetate, octyl butyrate, amyl acetate/pentyl acetate, pentyl butyrate/amyl butyrate, pentyl hexanoate/amyl caproate, pentyl pentanoate/amyl valerate, propyl ethanoate, propyl isobutyrate, terpenyl butyrate and mixtures thereof. Most preferred esters are methyl formate, ethyl formate, methyl acetate, and ethyl acetate, and mixtures thereof.

The ester can be added in combination with the blowing agent, or can be added separately from the blowing agent into the thermosetting foam blend by various means known in art. The typical amount of an ester is from about 0.1 wt % to 10 wt % of thermosetting foam blend, the preferred amount of an ester is from about 0.2 wt % to 7 wt % of thermosetting foam blend, and the more preferred amount of an ester is from about 0.3 wt % to 5 wt % of thermosetting foam blend.

The preparation of polyurethane or polyisocyanurate foams using the compositions described herein may follow any of the methods well known in the art can be employed. In general, polyurethane or polyisocyanurate foams are prepared by combining the isocyanate, the polyol pre-mix composition, and other materials such as optional flame retardants, colorants, or other additives. These foams can be rigid, flexible, or semi-rigid, and can have a closed cell structure, an open cell structure or a mixture of open and closed cells.

It is convenient in many applications to provide the components for polyurethane or polyisocyanurate foams in pre-blended formulations. Most typically, the foam formulation is pre-blended into two components. The isocyanate and optionally other isocyanate compatible raw materials comprise the first component, commonly referred to as the A-side component. The polyol mixture composition, including surfactant, catalysts, blowing agents, and optional other ingredients comprise the second component, commonly referred to as the B-side component. In any given application, the B-side component may not contain all the above listed components, for example some formulations omit the flame retardant if that characteristic is not a required foam property. Accordingly, polyurethane or polyisocyanurate foams are readily prepared by bringing together the A-side and B-side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a stream to the mix head or reaction site. Most conveniently, however, they are all incorporated into one B-side component as described above. In some circumstances, A-side and B-side can be formulated and mixed into one component in which water is removed. This is typical, for example, for a spray-foam canister containing a one-component foam mixture for easy application.

A foamable composition suitable for forming a polyurethane or polyisocyanurate foam may be formed by reacting an organic polyisocyanate and the polyol premix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry.

### EXAMPLES

The invention is further illustrated by reference to the following Examples.

### Example 1

164.2 grams of 2-methyl imidazole were added to 400 milliliters of toluene in a 1.5 liter flask. 116.0 grams of propylene oxide were then added to the flask equipped with a condensation column over 1 hour period. During this period, the flask was agitated and maintained at approximately 80° C. 271.8 grams of N-hydroxypropyl-2-methyl imidazole was recovered after removing the solvent from the reaction.

### Example 2

136.2 grams of imidazole were added to 300 milliliters of toluene in a 1.5 liter flask. 88.0 grams of ethylene oxide were then added to the flask equipped with a condensation column. The flask was agitated, after removing solvent, 206.1 grams of N-hydroxyethyl imidazole was recovered from the reaction.

TABLE 1
Summary of Example 1 and 2

| Example 1 | Example 2 |
|---|---|
| 2-methyl imidazole: 164.2 g | Imidazole: 136.2 g |
| Propylene oxide: 116.0 g | Ethylene oxide: 88.0 g |
| N-hydroxypropyl-2-methyl | N-hydroxyethylimidazole: |
| imidazole: 271.8 g | 206.1 g |

Examples 1 and 2 show the almost complete reaction between the imidazole and the oxide.

### Example 3—Comparative Example

Foams made were made (a) using PolyCat 8 (dimethylcyclohexylamine) with Polycat 5 (pentamethyldiethylenetriamine, PMDETA) and (b) using 1, 2-dimethylimidazole and ethylene glycol and were compared. An A-side (MDI) and B-side (mixture of the polyol, surfactant, catalysts, blowing agent, and additives) as set forth in Table 2 were mixed with a hand mixer and dispensed into a container to form a free rise foam. The formulations tested all had an Iso Index of 115 and each contained Rubinate M, a polymeric methylene diphenyl diisocyanate (MDI) available from Huntsman; Voranol 490, a polyol from Dow Chemical, Jeffol R-425-X, polyols from Huntsman; Stepan 2352, a polyol from Stepan Company. TegostabB 8465 a surfactant available from Evonik-Degussa. Antiblaze 80 is a flame retardant from Rhodia. PolyCat 8 (dimethylcyclohexylamine) and 5 (pentamethyldiethylenetriamine, PMDETA) are available from Air Products. The blowing was E-1233zd (trans 1-chloro-3,3,3-trifluoropropene). Total blowing agent level was 23.0 mls/g.

TABLE 2
Formulation

| | |
|---|---|
| Voranol 490 | 17.60 |
| Jeffol R-425-X | 10.63 |
| Stepan 2352 | 7.13 |
| PolyCat 5 | 0.16 |
| PolyCat 8 | 0.50 |
| Tegostab B8465 | 0.71 |
| Antiblaze 80 | 2.36 |
| Water | 0.70 |
| HCFO1233zd | 5.58 |
| Rubinate M | 52.60 |
| A/B | 1.11 |

A formulation was prepared in which the PolyCat 5 and Polycat 8 were replace with 1.40 wt % (based on total formula) of a mixture of 70 wt % of 1,2-dimethylimidazole and 30 wt %/o ethylene glycol. The initial reactivity was measured 3 using a hand-mixing method that would be known to a person skilled in the art and summarized in Table 3.

TABLE 3

| | | 70 wt % |
|---|---|---|
| | PC5 + PC8 | 1,2-dimethylimidazole |
| Cream time, sec | 12 | 22 |
| Gel time, sec | 40 | 55 |
| Tack free time, sec | 63 | 85 |

The data in Table 3 shows that the reactivity of 1, 2-dimethylimidazole containing foam at a much higher dosage is much slower than the control foam, which is the combination of PolyCat 5 and PolyCat 8. Particularly, the cream time is more than double of the control.

### Example 4

A formulation as in example 3 could be prepared in which 2.0 wt % (based on total formula) of a mixture of 70 wt % of 1,2-dimethylimidazole and 30 wt % ethylene glycol is replace by equal weight of 1-hydroxypropyl-2-methylimidazole. The initial reactivity could be measured using a hand-mixing method that would be known to a person skilled in the art and the expected results summarized in Table 4.

TABLE 4

| | 70 wt % 1-hydroxypropyl-2- |
|---|---|
| | methylimidazole |
| Cream time, sec | 16 |
| Gel time, sec | 49 |
| Tack free time, sec | 65 |

The reactivity data as in Table 4 would show that there is significant improvement in cream time when 1-hydroxypropyl-2-methylimidazole was used in place of 1,2-dimethylimidazole. The cream time is typically related to the reaction of water with MDI. Additionally, both gel and tack free times would also improved.

### Example 5

The formulation as described in Example 3, with two different catalyst packages: 1,2-dimethylimidazole, and PolyCat 5 and 8, were prepared. The dosages were as specified in Example 3 and 4. The two formulations were aged at 50° C. for 15 days and foam prepared as described in Example 3 and the properties compared to those in Table 3. Table 5 summarizes the % change in results.

TABLE 5

| | 70 wt % 1,2- | |
|---|---|---|
| | dimethylimidazole | PC 5 and PC 8 |
| Cream time, | +4.5 | +58.3 |
| (% change) | | |
| Gel time | +5.4 | +50.0 |
| (% change) | | |
| Tack free time | +5.8 | +50.8 |
| (% change) | | |

The data in Table 5 shows that the most reactive catalyst package, PC5 and 8, suffered from significant loss of reactivity after ageing. The 1,2-dimethylimidazole showed a much smaller loss in reactivity after aging.

### Example 6

The formulation as described in Example 3, with catalyst 1-hydroxypropyl-2-methylimidazole, could be prepared. The dosages would be as specified in Example 3 and 4. The formulation would be aged at 50° C. for 15 days and foam prepared as described in Example 4 and the properties would be compared to those in Table 4. Table 6 summarizes the % change in results expected.

TABLE 6

| | 70 wt % 1-hydroxypropyl-2- |
|---|---|
| | methylimidazole |
| Cream time, | <+10.0 |
| (% change) | |
| Gel time | <+10.0 |
| (% change) | |
| Tack free time | <+10.0 |
| (% change) | |

The data in Table 6 would show that after aging 1-hydroxypropyl-2-methylimidazole shows less than 10% of activity loss, similar to 1,2-dimethyl imidazole while the activity of 1-hydroxypropyl-2-methylimidazole was higher than for 1,2-dimethyl imidazole.

What is claimed is:

1. A stabilized thermosetting foam blend which comprises:
(a) a polyisocyanate and, optionally, one or more isocyanate compatible raw materials; and
(b) a polyol pre-mix composition which comprises a halogenated olefinic blowing agent, a polyol, a surfactant, and a catalyst composition comprising a non-amine catalyst and an amine catalyst consisting of a substituted imidazole having C2 or greater substitutions at the N1 nitrogen.

2. The stabilized thermosetting foam blend of claim 1, wherein the substituted imidazole having C2 or greater substitutions at the N1 nitrogen is selected from the group consisting of N-hydroxypropyl-2-ethyl-4-methyl imidazole, N-hydroxypropyl-2-methyl imidazole, N-hydroxypropyl-4-methyl imidazole, N-hydroxyethyl-4-methyl imidazole, N-hydroxyethyl-2-ethyl-4-methyl imidazole, N-hydroxyethyl-2-methyl imidazole, and mixture thereof.

3. The stabilized thermosetting foam blend of claim 1, wherein the substituted imidazole catalyst comprises greater than 50 wt % of a total of the catalysts composition.

4. The stabilized thermosetting foam blend of claim 1, wherein said amine catalyst is selected from the group consisting of bis-(2-dimethylaminoethyl)ether; N,N-dimethylethanolamine; N-ethylmorpholine; N-methylmorpholine; N,N,N′-trimethyl-N′-hydroxyethyl-bisaminoethylether; N-(3-dimethylaminopropyl)-N,N-diisopropanolamine; N,N-bis(3-dimethylaminopropyl)-N-isopropanolamine; 2-(2-dimethylaminoethoxy)ethanol; N,N,N′-trimethylaminoethyl-ethanolamine; and 2,2′-dimorpholinodiethylether, and mixtures thereof.

5. The stabilized thermosetting foam blend of claim 1, wherein the halogenated olefinic blowing agent comprises a halogenated hydroolefin and one or more hydrocarbons, alcohols, aldehydes, ketones, ethers/diethers, or CO₂ generating materials, or combinations thereof.

6. A method for stabilizing a thermosetting foam blend which comprises combining: (a) a polyisocyanate and, optionally, one or more isocyanate compatible raw materials; and (b) a polyol pre-mix composition which comprises a halogenated olefinic blowing agent, a polyol, a surfactant, and a catalyst composition comprising a non-amine catalyst and an amine catalyst consisting of a substituted imidazole having C2 or greater substitutions at the N1 nitrogen.

7. The method for stabilizing a thermosetting foam blend of claim 6, wherein said substituted imidazole having C2 or greater substitutions at the N1 nitrogen has the chemical structure: 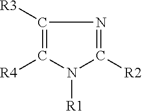
in which:
R1 is a C2 to C10 alkyl group, or a —CₙH₂ₙ₋₁(OH)R′1, or a —CₙH₂ₙOCₘH₂ₘ₋₁(OH)R′1 or a C2 to C10 alkenyl, or a C7 to C17 aryl; R′1 is H, or a C1 to C10 straight, branched, or cyclic alkyl group, or a C2 to C10 alkenyl, or C7 to C17 aryl; R2, R3, and R4 are H, or OH, or C1 to C10 alkyl group, or —CₙH₂ₙ₋₁(OH)R′1, or —CₙH₂ₙOCₘH₂ₘ₋₁OH)R′1 or C2 to C10 alkenyl, or C7 to C17 aryl; where R′1 is H, or C1 to C8 alkyl group, straight, or branched or cyclic alkyl group, or C2 to C10 alkenyl, or C7 to C17 aryl, and n and m are each independently from 1 to 6.

8. The method for stabilizing a thermosetting foam blend of claim 6, wherein the substituted imidazole catalyst comprises greater than 50 wt % of a total of the catalysts composition.

9. The method for stabilizing a thermosetting foam blend of claim 7, wherein said amine catalyst is selected from the group consisting of bis-(2-dimethylaminoethyl)ether; N,N-dimethylethanolamine; N-ethylmorpholine; N-methylmorpholine; N,N,N′-trimethyl-N′-hydroxyethyl-bisaminoethylether; N-(3-dimethylaminopropyl)-N,N-diisopropanolamine; N,N-bis(3-dimethylaminopropyl)-N-isopropanolamine; 2-(2-dimethylaminoethoxy)ethanol; N,N,N′-trimethylaminoethyl-ethanolamine; and 2,2′-dimorpholinodiethylether, and mixtures thereof.

10. The method for stabilizing a thermosetting foam blend of claim 7, wherein the a substituted imidazole having C2 or greater substitutions at the N1 nitrogen blowing agent comprises a halogenated hydroolefin and one or more hydrocarbons, alcohols, aldehydes, ketones, ethers/diethers, or CO₂ generating materials.
